(19) United States
(12) Patent Application Publication
(10) Pub. No.: US 2025/0217582 A1
(43) Pub. Date: Jul. 3, 2025

(54) SCREEN CREATION SYSTEM AND SCREEN CREATION METHOD

(71) Applicant: FANUC CORPORATION, Minamitsuru-gun, Yamanashi (JP)

(72) Inventor: Nobuhiro HARA, Yamanashi (JP)

(21) Appl. No.: 18/853,503

(22) PCT Filed: Apr. 28, 2022
(86) PCT No.: PCT/JP2022/019284

§ 371 Date: Oct. 2, 2024

(51) Int. Cl. G06F 40/186; G05B 19/418

(52) U.S. Cl. CPC G06F 40/186; G05B 19/41835; G05B 2219/32128

(57) ABSTRACT

The present invention makes it possible for a template creator to have a created template applied to many more business screens, and makes it possible for a screen user who creates (customizes) a business screen utilizing the template to simplify the setup creation work needed for each project to which the template is applied. This screen creation system comprises: a setup information creation unit for creating, on the basis of a setup item and a setup condition preliminarily defined for the whole of a selected template screen and for each of constituent elements of the template screen, setup information for each setup item that is defined for the whole of the template screen or the constituent element of the template screen; and a screen creation unit for creating a screen on the basis of the template screen and the setup information created by the setup information creation unit.

### TECHNICAL FIELD

The present invention relates to a screen creation system, and a screen creation method.

### BACKGROUND ART

Conventionally, a technique of generating a screen for a task by a user customizing a template screen created in advance, on the basis of this template screen (e.g., a BI (Business Intelligence) tool, SCADA (Supervisory Control And Data Acquisition, etc.) has been known.

Furthermore, according to a conventional art, it has been known that for a display item and display size selected by an operator, a plurality of divided screens corresponding to the display size are displayed on a screen on the basis of display information in a divided screen storage area, and when the operator designates any divided screen among the divided screens displayed on the screen, the display size and divided screen position information for the designated divided screen are stored in a customized screen storage area, thus freely customizing the display screen configuration as intended by the operator. For example, see Patent Document 1.

### CITATION LIST

### Patent Document

Patent Document 1: Japanese Unexamined Patent Application, Publication No. 2010-152992

### DISCLOSURE OF THE INVENTION

### Problems to be Solved by the Invention

However, there is a problem in that to apply the invention described in Patent Document 1 to various sites, e.g., factories, the template is required to be customized or set up depending on the difference in facility configurations of factories and functions and the like that the facilities have, and the difference in display items and layout data on task screens at each site and of each user, thus taking time and effort.

Accordingly, it is desired by a template creator to enable a created template to be applied to more task screens, and by a screen user creating (customizing) a task screen using the template to be able to simplify setup creation work required for each task screen to which the template is applied.

### Means for Solving the Problems

An aspect of a screen creation system in the present disclosure includes: a setup information creation unit configured to create, based on a setup item and a setup condition that are predefined for a selected template screen in entirety, or each of constituent elements of the template screen, setup information, with respect to each setup item defined for the template screen in entirety, or the constituent elements of the template screen; and a screen creation unit configured to create a screen, based on the template screen, and on the setup information created by the setup information creation unit.

An aspect of a screen creation method in the present disclosure includes: a selection step of selecting a template screen; a setup information creation step of creating, based on a setup item and a setup condition that are predefined for the template screen selected in entirety, or each of constituent elements of the template screen, setup information, with respect to each setup item defined for the template screen in entirety, or the constituent elements of the template screen; and a screen creation step of creating a screen, based on the template screen, and on the setup information created.

### Effects of the Invention

According to the one aspect, a template creator is able to apply a created template to more task screens, and a screen user creating (customizing) a task screen using the template is able to simplify setup creation work required for each task screen to which the template is applied.

### BRIEF DESCRIPTION OF THE DRAWINGS

FIG. 1 is a functional block diagram of a screen creation system according to one embodiment;

FIG. 2A is a figure showing an example of a facility master;

FIG. 2B is a figure showing an example of a facility status table;

FIG. 3 is a figure showing an example of a template screen;

FIG. 4 is a figure showing an example of setup items, and setup conditions;

FIG. 5 is a figure showing an example of a template screen;

FIG. 6 is a figure showing an example of setup items;

FIG. 7 is a figure showing an example of a creation screen for a template screen;

FIG. 8 is a figure showing an example of meta-information on a data source;

FIG. 9 is a figure showing an example of meta-information on a facility; and

FIG. 10 is a flowchart for illustrating a screen creation process of a screen creation device 1.

### PREFERRED MODE FOR CARRYING OUT THE INVENTION

Hereinafter, an embodiment of the present disclosure is described with reference to the drawings.

### One Embodiment

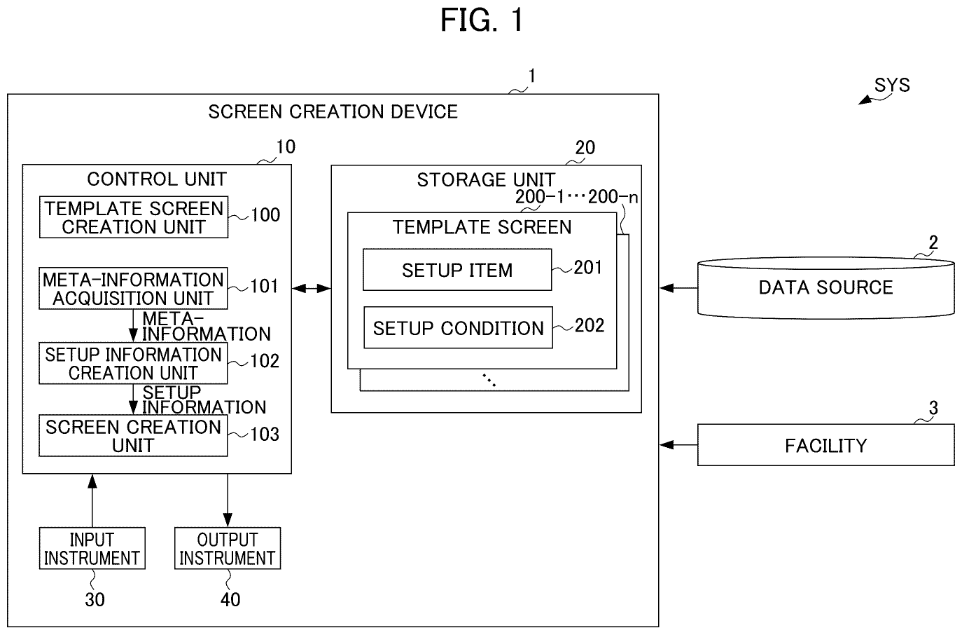

FIG. 1 is a functional block diagram of a screen creation system according to one embodiment.

As shown in FIG. 1, a screen creation system SYS includes a screen creation device 1, a data source 2, and a facility 3.

The screen creation device 1, the data source 2, and the facility 3 may be connected to each other via a network, not shown, such as a LAN (Local Area Network) or the Internet. In this case, the screen creation device 1, the data source 2, and the facility 3 each include communication unit, not shown, for mutual communication through such connection. Note that the screen creation device 1, the data source 2, and the facility may be connected to each other in a wired or wireless manner via a connection interface, not shown.

In FIG. 1, the screen creation device 1 is connected to the single data source 2, and the single facility 3, but may be connected to two or more data sources 2, and two or more facilities 3.

### Data Source 2

The data source 2 may be, for example, a data server, a cloud server, etc., and stores a facility master that indicates information related to the facility 3 arranged in each site, such as a factory, and data, such as a facility status table.

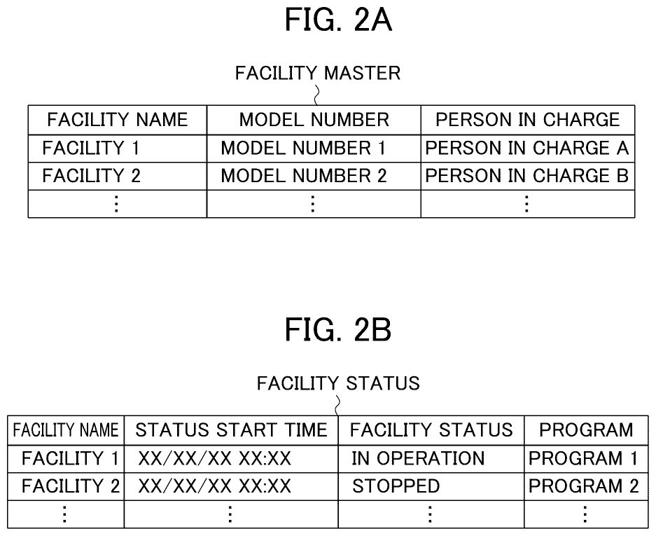

FIG. 2A is a figure showing an example of the facility master. FIG. 2B is a figure showing an example of a facility status.

As shown in FIG. 2A, the facility master includes storage areas, such as of “FACILITY NAME”, “MODEL NUMBER”, and “PERSON IN CHARGE”.

The storage area for “FACILITY NAME” in the facility master stores, for example, facility names, such as “FACILITY 1”, and “FACILITY 2”.

The storage area for “MODEL NUMBER” in the facility master stores, for example, model numbers, such as “MODEL NUMBER 1”, and “MODEL NUMBER 2”.

The storage area for “PERSON IN CHARGE” in the facility master stores, for example, “PERSON IN CHARGE A”, and “PERSON IN CHARGE B” that respectively indicate people in charge who take care with respect to the facilities with “FACILITY NAME”.

As shown in FIG. 2B, the facility status table includes storage areas for “FACILITY NAME”, “STATUS START TIME”. “FACILITY STATUS”, and “PROGRAM”.

The storage area for “FACILITY NAME” in the facility status table stores, for example, names of the facilities 3, such as “FACILITY 1”, and “FACILITY 2”.

The storage area for “STATUS START TIME” in the facility status table stores, for example, a start date and time at which the status of each facility 3 came into the current status.

The storage area for “FACILITY STATUS” in the facility status table stores, for example, “IN OPERATION”, “STOPPED”, and the like that indicate the current statuses of the respective facilities 3 each with a corresponding “FACILITY NAME”.

The storage area for “PROGRAM” in the facility status table stores, for example, “PROGRAM 1”, “PROGRAM 2”, and the like that indicate programs that are currently in execution or have been most recently executed with respect to the respective facilities 3 each with a corresponding “FACILITY NAME”.

Note that the data source 2 may further store production achievement information (a workpiece ID, a facility name, a processing step name, an outset time, a completion time, etc.).

### Facility 3

The facilities 3 are a numerical control device, a robot control device, a machine tool, a robot, and the like that are arranged at a site, such as a factory. Each facility 3 stores data, such as an executable function list that indicates executable functions. The facility 3 outputs the data, such as the executable function list, in conjunction with the facility status indicating the current status and the like to the screen creation device 1 and the data source 2.

### Screen Creation Device 1

The screen creation device 1 is, for example, a computer or the like, and is mutually connected to a display device (not shown), such as of a computer, which displays a screen related to fabrication at the facility 3, via the network, not shown, such as the LAN and the Internet.

Here, screens related to fabrication at the facility include, as examples: for instance, a factory monitoring screen, a facility status verification screen, an OEE (Overall Equipment Effectiveness) verification screen, a screen for recording the outset and completion of a processing step, etc., as screens related to production; a screen for registering maintenance achievement, a screen for registering a maintenance plan, a screen for referring to a maintenance history, etc., as screens related to facility maintenance, and a screen for registering a measurement result of a product, a screen for grasping the tendency of the measurement result of the product, etc., as screens related to the quality of the product. However, there is no limitation thereto. They are applicable to any screen related to facility fabrication.

Thus, the core created in conformity with the facility by the screen creation device 1 is applied to the display device (not shown) as described later. The display device (not shown) displays the screen created by the screen creation device 1, on a display unit (not shown), such as e.g., a liquid crystal display, thus displaying the screen related to fabrication at the facility (not shown), such as a numerical control device. Note that the screen creation device 1 may be directly connected mutually to the display device (not shown) via the connection interface, not shown.

As described later, the screen creation device 1 is a device different from the display device (not shown), but may include the display device (not shown).

As shown in FIG. 1, the screen creation device 1 includes: control unit 10; a storage unit 20; an input instrument 30, such as a keyboard, a mouse, or a touch panel; and an output instrument 40, such as a liquid crystal display. The control unit 10 includes a template screen creation unit 100, a meta-information acquisition unit 101, a setup information creation unit 102, and a screen creation unit 103.

### Storage Unit 20

The storage unit 20 may be an SSD (Solid State Drive), an HDD (Hard Disk Drive), etc. The storage unit 20 stores n template screens 200-1 to 200-n (n is an integer equal to or greater than 1) in conjunction with an operating system, an application program, and the like that are executed by the control unit 10.

Hereinafter, when the template ns 200-1 to 200-n are not required to be individually distinguished from each other, they are also collectively called “template screen 200”.

The template screen 200 is, for example, template data of a screen created in advance based on a template screen creator's operation by the template screen creation unit 100 described later. As shown in FIG. 1, the template screen 200 includes a setup item 201 and a setup condition 202 that are predefined by the template screen creator.

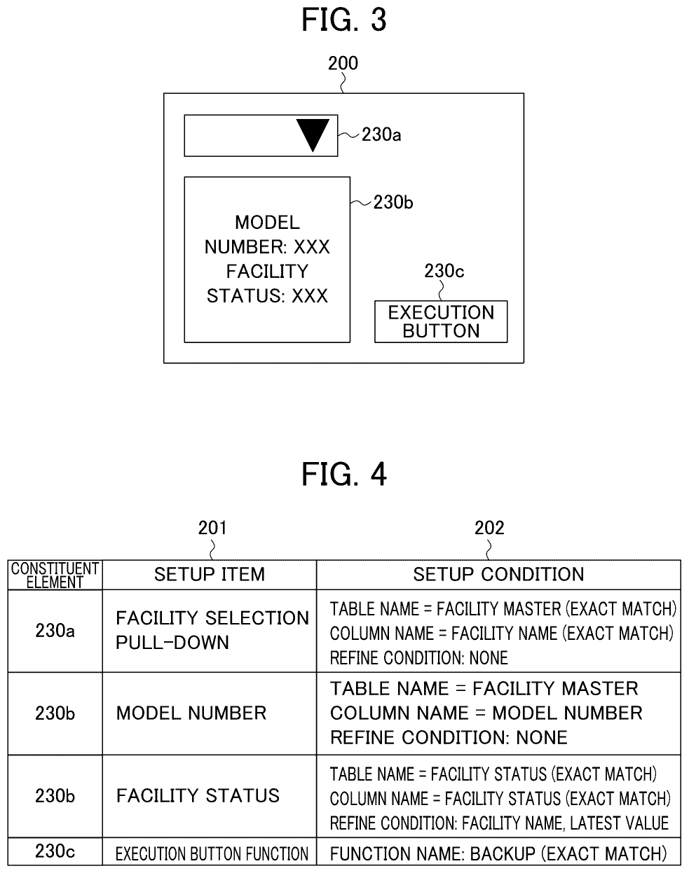

FIG. 3 is a figure showing an example of the template screen 200, FIG. 4 is a figure showing an example of the setup item 201, and the setup condition 202.

As shown in FIG. 3, for example, three constituent elements 230a to 230c are set on the template screen 200.

As shown in FIG. 4, in the setup item 201, setup items are set for the respective constituent elements 230a to 230c. For example, for the constituent element 230a, a template for displaying a list of facilities and displaying a selectable facility selection pull-down is set. It is set so that for the constituent element 230b, a template for displaying the model number and the facility status of the facility selected through the facility selection pull-down for the constituent element 230a can be displayed. For the constituent element 230c, a template for displaying an execution button is set.

In the setup condition 202, conditions of functions set for the respective items in the setup item 201 are set based on meta-information on the data of the data source 2 and the data of the facility 3 obtained from the meta-information acquisition unit 101 described later. For example, to display the list of facilities on the facility selection pull-down for the constituent element 230a, in the meta-information on the data of the data source 2 obtained from the meta-information acquisition unit 101 described later, “FACILITY MASTER” is set as a table name (file name), “FACILITY NAME” is set as a column name of data in “FACLITY MASTER”, and “NONE” is set as a refine condition for the data, in the setup condition 202. Note that in the setup condition 202 in FIG. 4, a condition of exact match is also set for each of the table name “FACILITY MASTER”, and the column name “FACILITY NAME”.

The constituent element 230b includes two setup items (the model number, and the facility status).

As for the model number, to display the model number of the facility on the facility selection pull-down for the constituent element 230b, in the meta-information on the data of the data source 2 obtained from the meta-information acquisition unit 101 described later, “FACILITY MASTER” is set as a table name (file name), “MODEL NUMBER” is set as a column name of data in “FACLITY MASTER”, and “NONE” is set as a refine condition for the data, in the setup condition 202.

As for the facility status, to display the facility status of the facility on the facility selection pull-down in the constituent element 230b, in the meta-information on the data of the data source 2 obtained from the meta-information acquisition unit 101 described later, “FACILITY STATUS” is set as a table name (file name), “FACILITY STATUS” is set as a column name of data for “FACILITY STATUS”, and “FACILITY NAME” and “LATEST VALUE” are set as refine conditions for the data, in the setup condition 202. Note that in the setup condition 202 (facility status) for the constituent element 230b in FIG. 4, a condition of exact match is also set for the table name “FACILITY STATUS”, and the column name “FACILITY STATUS”.

To cause the execution button displayed in the constituent element 230c to function as a backup, in the setup condition 202, “BACKUP” is set as a function name in the meta-information on the data of the executable function list stored in the facility 3. Note that in the setup condition 202 (execution button function) of the constituent element 230c in FIG. 4, a condition of exact match is also set for the function name “BACKUP”.

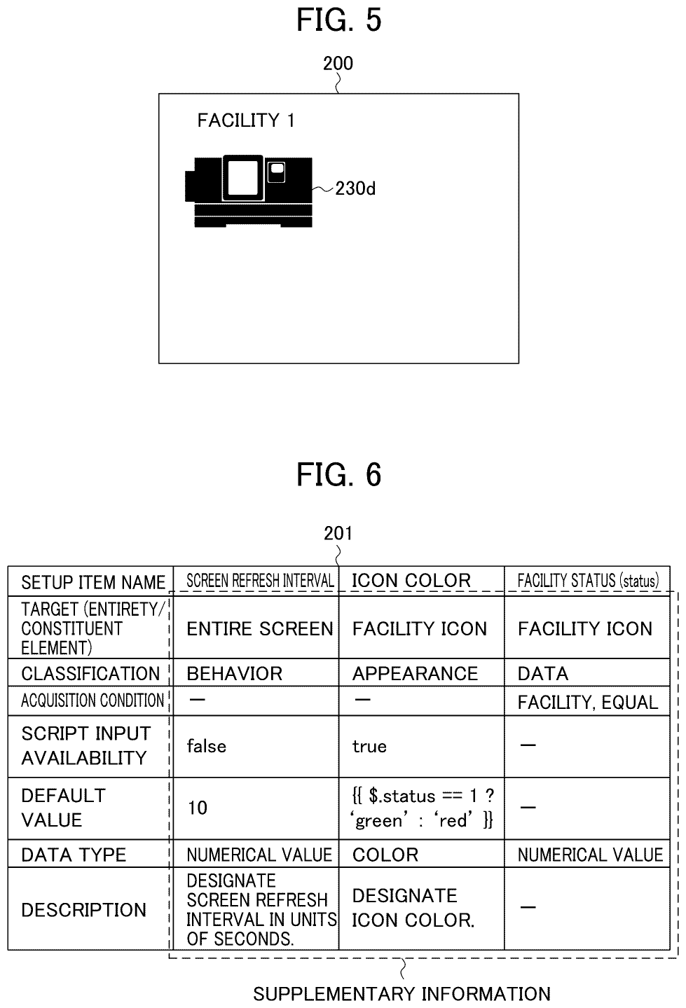

Note that as shown in FIG. 5, the template screen 200 may include a constituent element 230d, which is one facility icon. In this case, as shown in FIG. 6, the setup item 201 for the constituent element 230d may include supplementary information.

That is, the setup item 201 for the constituent element 230d includes “SCREEN REFRESH INTERVAL”, “ICON COLOR”, and “FACILITY STATUS (status)”. The setup item 201 includes items on the second row and thereafter surrounded by broken lines, as supplementary formation for setup items of “SCREEN REFRESH INTERVAL”, “ICON COLOR”, and “FACILITY STATUS (status)”, i.e., “TARGET (ENTIRETY/CONSTITUENT ELEMENT)”, “CLASSIFICATION”, “ACQUISITION CONDITION”, “SCRIPT INPUT AVAILABILITY”, “DEFAULT VALUE”, “INPUT TYPE”, and “DESCRIPTION”. Such supplementary information is a type of setup condition 202 for the setup item.

The storage area for “TARGET (ENTIRETY/CONSTITUENT ELEMENT)” in the supplementary information stores setup values indicating whether the entire template screen is regarded as a target, or a specific constituent element is regarded as a target, for the respective setup items included in the setup item 201 (“SCREEN REFRESH INTERVAL”, “ICON COLOR”, “FACILITY STATUS (status)”), The supplementary information in FIG. 6 stores setup values of “ENTIRE SCREEN”, “FACILITY ICON”, and “FACILITY ICON”, for the respective setup items of “SCREEN REFRESH INTERVAL”, “ICON COLOR”, “FACILITY STATUS (status)”.

The storage area for “CLASSIFICATION” in the supplementary information stores classifications of the respective setup items. The supplementary information in FIG. 6 stores classifications of “BEHAVIOR”, “APPEARANCE”, and “DATA”, for the respective setup items of “SCREEN REFRESH INTERVAL”, “ICON COLOR”, “FACILITY STATUS (status)”.

The storage area for “ACQUISITION CONDITION” in the supplementary information stores items to be set (multiple designations allowed), as acquisition conditions of data if the “CLASSIFICATION” is data. The supplementary information in FIG. 6 stores acquisition conditions of “FACILITY” and “EQUAL”, for the setup item of “FACILITY STATUS (status)” with “CLASSIFICATION” of data. Note that “ACQUISITION CONDITION” of each of “SCREEN REFRESH INTERVAL” and “ICON COLOR” is blank “-” because “CLASSIFICATION” indicates “BEHAVIOR” and “APPEARANCE”.

The storage area for “SCRIPT INPUT AVAILABILITY” in the supplementary information stores whether a script can be set (true) or not (false), as a setup value. The supplementary information in FIG. 6 stores “false”, “true”, and “- (blank)”, for the respective setup items of “SCREEN REFRESH INTERVAL”, “ICON COLOR”, and “FACILITY STATUS (status)”.

The storage area for “DEFAULT VALUE” in the supplementary information stores a value as an initial value for the setup item concerned. The supplementary information in FIG. 6 stores “10”, “{{$.status==1? ‘green’:‘red’}}”, and “- (blank)”, for the respective setup items of “SCREEN REFRESH INTERVAL”, “ICON COLOR”, and “FACILITY STATUS (status)”. Note that “10” indicates that the screen refresh interval is 10 seconds. “{{$.status==1? ‘green’:‘red’}}” is in, for example, JavaScript®. In a case where the variable of “status” set in the data is “1”, the color of the facility icon is set to be “green”. In the other cases, the color of the facility icon is set to be “red”.

The storage area for “DATA TYPE” in the supplementary information stores the type of data on the setup value. The supplementary information in FIG. 6 stores “NUMERICAL VALUE”, “COLOR”, and “NUMERICAL VALUE”, for the respective setup items of “SCREEN REFRESH INTERVAL”, “ICON COLOR”, and “FACILITY STATUS (status)”.

The storage area for “DESCRIPTION” in the supplementary information stores a description for conveying the meaning of the setup item to the template creator and the screen user. The supplementary information in FIG. 6 stores “DESIGNATE SCREEN REFRESH INTERVAL IN UNITS OF SECONDS.”, “DESIGNATE ICON COLOR.”, “- (blank)”, for the respective setup items of “SCREEN REFRESH INTERVAL”, “ICON COLOR”, and “FACILITY STATUS (status)”.

### Control Unit 10

The control unit 10 includes a CPU, a ROM, a RAM, a CMOS memory, and the like, which are configured to be mutually communicable via a bus, and are publicly known to those skilled in the art.

The CPU is a processor that controls the screen creation device 1 as a whole. The CPU reads system programs and application programs stored in the ROM via the bus, and controls the screen creation device 1 as a whole according to the system programs and the application programs. Accordingly, as shown in FIG. 1, the control unit 10 is configured to achieve the functions of the template screen creation unit 100, the meta-information acquisition unit 101, the setup information creation unit 102, and the screen creation unit 103. The RAM stores various data items, such as temporary calculation data, and display data. The CMOS memory is backed up by a battery, not shown, and is thus configured as a non-volatile memory where the storage state is held even when the power source of the screen creation device 1 is turned off.

Note that in the present embodiment, the example of the configuration where the screen creation device 1 includes the template screen creation unit is described. However, there is no Limitation thereto. The template screen creation unit may be configured as a template creation device (not shown), which is a device different from the screen creation device 1. That is, the template creator can create a template screen through the template creation device (not shown), and provide the created template screen to a large number of users.

Before the functions of the template screen creation unit 100, the meta-information acquisition unit 101, the setup information creation unit 102, and the screen creation unit 103 are described in detail, the outline of the operation of each function is herein described.

The template screen creation unit 100 creates the template screen 200 conforming to the function of the facility and the site, such as a factory, based on an input operation by the template creator through the input instrument 30, and stores the created template screen 200 in the storage unit 20.

The meta-information acquisition unit 101 acquires the meta-information on the data stored in the data source 2, the facility 3, and the like, from the data source 2, the facility 3, and the like, and outputs the acquired meta-information to the setup information creation unit 102.

The setup information creation unit 102 reads, from the storage unit 20, the template screen 200 selected by the screen user, who generates (customizes) the task screen using the template screen, and creates the setup information with respect to each setup item for the entire template screen 200 or for each of the constituent elements 230a to 230c of the template screen, based on the setup item 201 and the setup condition 202 predefined for the read template screen 200 and on the meta-information input from the meta-information acquisition unit 101. The setup information creation unit 102 outputs the created setup information to the screen creation unit 103.

The screen creation unit 103 creates the screen related to fabrication at the facility, based on the template screen 200 and on the setup information created by the setup information creation unit 102, and applies the created screen as a screen related to facility fabrication on the display device, not shown.

### Template Screen Creation Unit 100

The template screen creation unit 100 creates the template screen 200 conforming to the function of the facility and the site, such as a factory, based on an input operation by the template creator through the input instrument 30, and stores the created template screen 200 in the storage unit 20.

Specifically, for example, upon acceptance of an instruction for creating the template screen 200 through an input operation by the template creator, the template screen creation unit 100 displays a creation screen 300 for the template screen 200, on the output instrument 40.

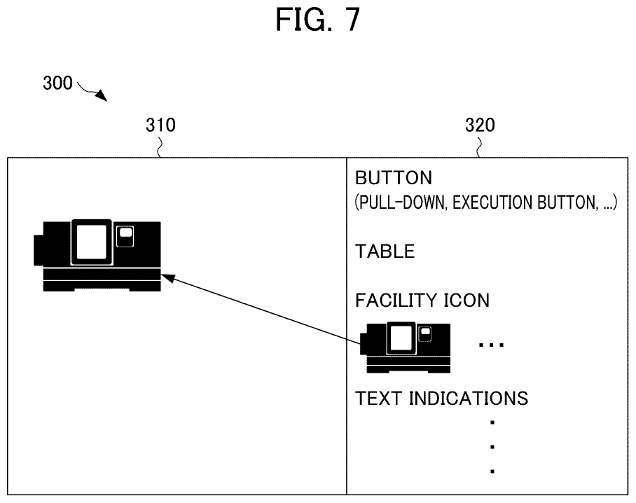

FIG. 7 is a figure showing an example of the creation screen 300 for the template screen 200.

As shown in FIG. 7, the creation screen 300 includes a template screen setup area 310, and a constituent element list 320. Note that the constituent element list 320 includes, as constituent elements: for example, buttons (pull-down, and execution button, etc.); a table; a facility icon; and text indications. For each of the constituent elements, a default setup item 201 of the corresponding constituent element and its supplementary information, and the setup condition 202 may be set.

For example, as shown in FIG. 7, the template screen creation unit 100 arranges and determines the facility icon at a desired position, by drag-and-drop of the facility icon through the template creator's input operation. Note that after determination of the facility icon and its arrangement position, the template screen creation unit 100 may automatically generate a source code for the template screen 200, based on an input operation by the template creator, and based on the type and arrangement position of the constituent element, and edit the source code (for example, add logic) as required. The template screen creation unit 100 may create or correct the setup item 201 for the constituent element and its supplementary information (for example, adjust the setup item), create or correct the setup condition 202, and the like, as required, based on an input operation by the template creator. The template screen creation unit 100 may create a new template screen 200, based on the existing template screen 200. The template screen creation unit 100 may internally include a debug function for the template screen 200.

The template screen creation unit 100 stores, in the storage unit 20, as the template screen 200, data including the setup item 201 and the supplementary information, and the setup condition 202, which are set to the template screen setup area 310.

### Meta-Information Acquisition Unit 101

The meta-information acquisition unit 101 acquires the meta-information on the data stored in the data source 2, the facility 3, and the like, from the data source 2, the facility 3, and the like, and outputs the acquired meta-information to the setup information creation unit 102.

Specifically, the meta-information acquisition unit 101 acquires, for example, metadata related to the facility at each site, such as a factory, stored in the data source 2 (the facility name, model number/name, person in charge, status start time information, facility status information, program name, etc.), and metadata related to the facility stored in the facility 3 (the facility name, function name, etc.), which are then registered in advance. Note that in the facility 3, the list of the executable functions of the facility 3 may be registered in advance, and connection information on the facility 3 intended to be set at each site (e.g., an IP address etc.) may be registered. Database connection destination information (e.g., an IP address, a password, etc.) may be registered in advance, and the meta-information acquisition unit 101 may execute a query, and acquire the meta-information.

The meta-information acquisition unit 101 may use a meta-information acquisition function that is included in an IoT (Internet of Things) platform and is of the facility or of software (an interface for invoking the function (RPC: Remote Procedure Call) etc.) for communicating with the facility. Preferably, in this case, the IoT platform discloses a document that is for the user and indicates which meta-information (an interface (RPC) for invoking the function) the facility or the software (converter) for communicating with the facility has. Accordingly, the template creator can grasp the function included in the facility in advance, and then create the setup condition 202 for the template screen 200.

The IoT platform defines common meta-information (interface) about the function that is common irrespective of facilities (e.g., file transmission, file acquisition, acquisition of a file list, file deletion, variable setting, variable acquisition, etc.). If the facility supporting the common function or software communicating with the facility is used, the template creator can create the setup condition 202 for the template screen 200 without considering the facility.

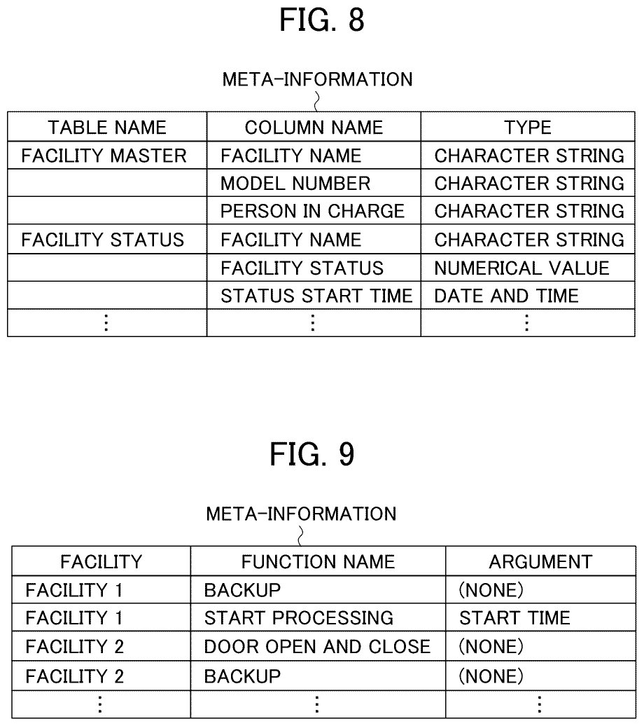

As shown in FIG. 8, for example, in a case where the data is a database, the meta-information acquisition unit 101 acquires the list of tables, and the list of column names and types of each table, as meta-information on the data, from the data source 2.

FIG. 8 is a figure showing an example of the meta-information on the data source 2.

As shown in FIG. 8, the meta-information includes storage areas for “TABLE NAME”, “COLUMN NAME”, and “TYPE”.

The storage area for “TABLE NAME” in the meta-information stores, for example, a table (data), such as “FACILITY MASTER”, and “FACILITY STATUS”.

The storage area for “COLUMN NAME” in the meta-information stores, for example, column names, such as “FACILITY NAME”, “MODEL NUMBER”, “PERSON IN CHARGE”, “FACILITY NAME”, “FACILITY STATUS”, and “STATUS START TIME”.

The storage area for “TYPE” in the meta-information stores, for example, data types, such as “CHARACTER STRING”, “DATE AND TIME”, and “NUMERICAL VALUE”, with respect to each column name “COLUMN NAME”.

Note that in a case where ca is a CSV file or the like, the meta-information acquisition unit 101 may acquire a list of file names or the header names of the respective files, as meta-information.

As shown in FIG. 9, in a case of the meta-information on the facility 3, the meta-information acquisition unit 101 may acquire a list of functions (interfaces) executable in the facility and arguments.

FIG. 9 is a figure showing an example of the meta-information on the facility 3.

As shown in FIG. 9, the meta-information on the facility 3 includes storage areas for “FACILITY”, “EXECUTABLE FUNCTION”, and “ARGUMENT”.

It is understood that the storage area for “FACILITY” in the meta-information on the facility 3 acquired by the meta-information acquisition unit 101 stores, for example, facilities, such as “FACILITY 1”, and “FACILITY 2”.

It is understood that the storage area for “FUNCTION NAME” in the acquired meta-information on the facility 3 stores, for example, functions, such as of “BACKUP”, “START PROCESSING”, and “DOOR OPEN AND CLOSE”.

It is understood that the storage area for “ARGUMENT” in the acquired meta-information on the facility 3 stores, for example, arguments, such as “START TIME”, with respect to each function of “EXECUTABLE FUNCTION”.

Note that in the case of the meta-information on the facility 3, the meta-information acquisition unit 101 may acquire the type of the data, the file name, type, and the like that can be acquired from the facility.

### Setup Information Creation Unit 102

For example, the setup information creation unit 102 reads, from the storage unit 20, the template screen 200 selected by the screen user, who generates (customizes) the task screen using the template screen, and creates the setup information with respect to each setup item for the entire template screen 200 or for each of the constituent elements 230a to 230c of the template screen, based on the setup item 201 and the setup condition 202 predefined for the read template screen 200 and on the meta-information input from the meta-information acquisition unit 101. The setup information creation unit 102 outputs the created setup information to the screen creation unit 103.

Specifically, for example, the setup information creation unit 102 acquires candidates of corresponding setting by matching the meta-information acquired by the meta-information acquisition unit 101 against the setup condition 202 for each setup item 201, For example, the setup information creation unit 102 searches the storage area for “TABLE NAME” in the meta-information in FIG. 8, and retrieves the table name exactly matching the table name of “FACILITY MASTER” in the setup condition 202 for “FACILITY SELECTION PULL-DOWN” for the setup item 201 in FIG. 4. Since “FACILITY MASTER” is present in the meta-information in FIG. 8, the setup information creation unit 102 then searches the storage area for “COLUMN NAME” in the meta-information in FIG. 8, and retrieves the column name exactly matching the column name of “FACILITY NAME” in the setup condition 202 for “FACILITY SELECTION PULL-DOWN” for the setup item 201 in FIG. 4. Accordingly, since “FACILITY NAME” is in the meta-information in FIG. 8, the setup information creation unit 102 sets information (e.g., a query for the data source 2, a file path, etc.) for acquiring data from the facility master in FIG. 2A, as setup information (candidates) on the setup item in the facility selection pull-down for the constituent element 230a.

The setup information creation unit 102 searches the storage area for “TABLE NAME” in the meta-information in FIG. 8, and retrieves the table name exactly matching the table name of “FACILITY MASTER” in the setup condition 202 for “MODEL NUMBER” for the setup item 201 in FIG. 4. Since “FACILITY MASTER” is present in the meta-information in FIG. 7, the setup information creation unit 102 then searches the storage area for “COLUMN NAME” in the meta-information in FIG. 8, and retrieves the column name exactly matching the column name of “MODEL NUMBER” in the setup condition 202 for “MODEL NUMBER” for the setup item 201 in FIG. 4. Since “MODEL NUMBER” is in the meta-information in FIG. 8, the setup information creation unit 102 creates information (e.g., a query for the data source 2, a file path, etc.) for acquiring data from the facility master in FIG. 2A, as setup information (candidates) on the setup item in the model number for the constituent element 230b.

The setup information creation unit 102 searches the storage area for “TABLE NAME” in the meta-information in FIG. 8, and retrieves the table name exactly matching the table name of “FACILITY STATUS” in the setup condition 202 for “FACILITY STATUS” for the setup item 201 in FIG. 4. Since “FACILITY STATUS” is present in the meta-information in FIG. 8, the setup information creation unit 102 then searches the storage area for “COLUMN NAME” in the meta-information in FIG. 8, and retrieves the column name exactly matching the column name of “FACILITY STATUS” in the setup condition 202 for “FACILITY STATUS” for the setup item 201 in FIG. 4. Since “FACILITY STATUS” is in the meta-information in FIG. 8, the setup information creation unit 102 creates information (e.g., a query for the data source 2, a file path, etc.) for acquiring data from the facility status in FIG. 28, as setup information (candidates) on the setup item in the facility status for the constituent element 230b.

The setup information creation unit 102 searches the meta-information on the facility in FIG. 9, and retrieves the function name exactly matching the function name of “BACKUP” in the setup condition 202 for “EXECUTION BUTTON FUNCTION” in the setup item 201 in FIG. 4. Since “BACKUP” is in the meta-information on the facility in FIG. 9, the setup information creation unit 102 creates the meta-information on the facility in FIG. 9 (e.g., the table, column name, file name, etc.), as the setup information (candidates) on the setup item of the execution button of the constituent element 230c.

The setup information creation unit 102 then outputs, to the screen creation unit 103, the setup information created for each setup item for the entire template screen 200 or for each of the constituent elements 230a to 230c of the template screen 200.

Note that the setup information creation unit 102 matches the meta-information acquired from the meta-information acquisition unit 101 against the setup condition 202 for each setup item 201, and obtains candidates, based on the exact match of text. However, there is no limitation thereto. For example, the setup information creation unit 102 may obtain the candidates, based on partial match between the meta-information acquired from the meta-information acquisition unit 101, and the setup condition 202 for each setup item 201.

Alternatively, the setup information creation unit 102 may calculate the similarity of text between the meta-information acquired by the meta-information acquisition unit 101, and the setup condition 202 for each setup item 201, using a publicly known method, and output candidates in a descending order of similarity or in an order of similarity. The setup information creation unit 102 may then display, for example, an output result of candidates to the output instrument 40. If the output result is undesirable for the screen user who generates (customizes) a task screen using the template screen, the setup information creation unit 102 may display a list of candidates to the output instrument 40, and output candidates desired by the screen user.

To calculate the data content similarity between the meta-information acquired by the meta-information acquisition unit 101 and the setup condition 202 for each setup item 201, with respect to each of the setup conditions 202, such as the table name and the column name, the setup information creation unit 102 may learn the features of data with respect to each setup condition 202 in advance, and thus calculate the similarity.

The setup information creation unit 102 matches the meta-information acquired by the meta-information acquisition unit 101 against the setup condition 202 for each setup item 201, and outputs the setting as the setup information to the screen creation unit 103, described later, if the number of candidates of corresponding setting is one. On the other hand, if the number of candidates of the corresponding setting is two or more, the setup information creation unit 102 may issue a notification indicating that the number of candidates is two or more, and allow the screen user generating (customizing) the task screen to make a selection using the template screen. For example, the setup information creation unit 102 may display a screen for selection of multiple candidates on the output instrument 40, thus allowing the screen user to make a selection.

If the number of candidates of setting is zero, the setup information creation unit 102 may automatically generate no setup information, and output no information to the screen creation unit 103, described later. In this case, for example, the setup information creation unit 102 may display, on the output instrument 40, a screen for allowing the screen user generating (customizing) the task screen using the template screen to configure setting, create setup information, based on manual setting by the screen user, and output the information to the screen creation unit 103.

### Screen Creation Unit 103

The screen creation unit 103 creates a screen related to fabrication at the facility, based on the template screen 200 and on the setup information created by the setup information creation unit 102. The screen creation unit 103 can apply the created screen as the screen related to fabrication at the facility on the display device, not shown. For example, the screen creation device 1 may be linked to a task system, not shown, and provide the created screen for the task system, not shown.

### Screen Creation Process of Screen Creation Device 1

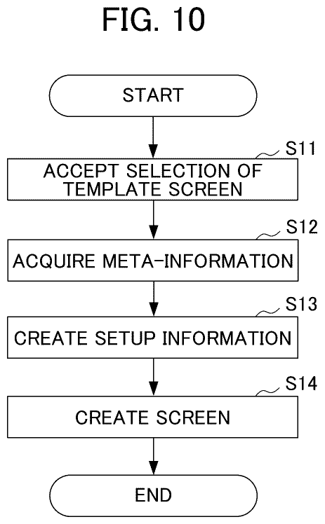

Next, referring to FIG. 10, the flow of a screen creation process of the screen creation device 1 is described.

FIG. 10 is a flowchart for illustrating the screen creation process of the screen creation device 1. The flow described here is repetitively executed every time the screen user selects the template screen 200.

In Step S11, the screen creation device 1 (control unit 10) accepts selection of the template screen 200 by the screen user through the input instrument 30.

In Step S12, the screen creation device 1 (meta-information acquisition unit 101) acquires the meta-information on the data of the data source 2 and on the data of the facility 3, etc.

In Step S13, the screen creation device 1 (setup information creation unit 102) creates the setup information with respect to each setup item for the entire template screen 200 or for each of the constituent elements 230a to 230c of the template screen 200, based on the setup item 201 and the setup condition 202 predefined for the template screen 200 selected in Step S11.

In Step S14, the screen creation device 1 (screen creation unit 103) creates the screen, based on the template screen 200 selected in Step S11 and on the setup information created in Step S13.

As described above, the screen creation system SYS according to one embodiment includes the template screens 200-1 to 200-n including t predefined setup item 201 and the setup condition 202, and acquires the meta-information on the data of the data source 2 and on the data of the facility 3 when the template screen 200 is selected by the screen user. The screen creation system SYS creates the setup information with respect to each setup item for the entire template screen 200 or for each of the constituent elements 230a to 230c of the template screen, based on the setup item 201 and the setup condition 202 for the selected template screen 200 and on the acquired meta-information, and generates the screen, based on the generated setup information and the selected template screen 200. Accordingly, the screen creation system SYS enables the template creator to apply the created template to more task screens, and enables the screen user creating (customizing) the task screen using the template to simplify the required setup creation work (e.g., the facility configuration at each site (factory or the like), the function that each facility bas, the difference in data name at each site (difference in data type), etc.) with respect to each task screen to which the template is applied.

Although one embodiment has been described above, the screen creation system SYS is not limited to the embodiment. described above, and encompasses modifications and improvements in a range capable of achieving the object.

### Modification Example

In one embodiment, the screen creation device 1 is assumed as a device different from the display device that displays a screen related to fabrication at each of facilities (not shown), such as the numerical control device, a robot control device, a machine tool, and a robot, which are arranged at a site, such as a factory, and are not shown. However, there is no limitation thereto. For example, the screen creation device 1 may include the display device (not shown).

Note that each function included in the screen creation system SYS according to one embodiment can be achieved by hardware, software, or a combination of them. Here, achievement by software means achievement by a computer reading and executing a program.

The program can be stored using various types of non-transitory computer-readable mediums, and be supplied to a computer. The non-transitory computer-readable media include various types of tangible storage media. Examples of the non-transitory put-readable media include magnetic recording media (e.g., a flexible disk, magnetic tape, and hard disk drive), a magnetooptical recording media (e.g., an magnetooptical disk), a CD-ROM (Read Only Memory), a CD-R, CD-R/N, semiconductor memories (e.g., a mask ROM, a PROM (Programmable, an EPROM (Erasable PROM), a flash ROM, and a RAM). The program may be supplied to a computer by various types of transitory computer-readable mediums. Examples of transitory computer-readable media include an electric signal, an optical signal, and electromagnetic waves. The transitory computer-readable media can supply the program to the computer through a wired communication paths, such as an electric wire and an optical fiber, or a wireless communication path.

Steps of describing the program to be recorded on a recording medium include not only processes that are executed in time sequence according to the respective order, but also processes that are executed in parallel or individually and not necessarily in time sequence.

In other words, the screen creation system, and the screen creation method in the present disclosure can be implemented as various types and various modes of embodiments having the following configurations.
(1) A screen creation system SYS in the present disclosure includes: a setup information creation unit 102 configured to create, based on a setup item 201 and a setup condition 202 that are predefined for a template screen 200 in entirety, or each of constituent elements 230a to 230c of the template screen 200, setup information, with respect to each setup item 201 defined for the template screen 200 in entirety, or the constituent elements 230a to 230c of the template screen 200; and a screen creation unit 103 configured to create a screen, based on the template screen 200, and on the setup information created by the setup information creation unit 102.

According to the screen creation system SYS, for the template creator, the created template can be applied to wider variety of screen users, and for the screen users, the setup creation work required for each task screen to which the template is applied can be simplified.
(2) The screen creation system SYS according (1) may further include a meta-information acquisition unit 101 configured to acquire meta-information on data, wherein the setup information creation unit 102 may set, as the setup information, the meta-information acquired by the meta-information acquisition unit 101.

Accordingly, the screen creation system SYS can create a screen that conforms more closely to the application destination (site);
(3) The screen creation system IS according to (2), wherein the meta-information acquisition unit 101 may also acquire meta-information on a facility, as the meta-information on the data, and the setup information creation unit 102 may set, as the setup information, the meta-information on the facility acquired by the meta-information acquisition unit 101.

Accordingly, the screen creation system SYS can create a screen that conforms to the type of the facility at the application destination (site).
(4) A screen creation method in the present disclosure includes: a selection step of selecting a template screen 200; a setup information creation step of creating, based on a setup item 201 and a setup condition 202 that are predefined for the template screen 200 selected in entirety, or each of constituent elements 230a to 230c of the template screen 200, setup information, with respect to each setup item 201 defined for the template screen 200 in entirety, or the constituent elements 230a to 230c of the template screen 200; and a screen creation step of creating a screen, based on the template screen 200, and on the setup information created.

According to the screen creation method, advantageous effects similar to those in (1) can be exerted.
(5) The screen creation method according to (4) may further include a meta-information acquisition step of acquiring meta-information on data, wherein the setup information creation step may set the meta-information acquired, as the setup information.

Accordingly, the screen creation method can exert advantageous effects similar to those of (2).
(6) In the screen creation method according to (5), wherein the meta-information acquisition step may also acquire meta-information on a facility, as the meta-information on the data, and the setup information creation step may set the meta-information on the facility acquired, as the setup information.

Accordingly, the screen creation method can exert advantageous effects similar to those in (3).

### EXPLANATION OF REFERENCE NUMERALS

1 Screen creation device
10 Control unit
100 Template screen creation unit
101 Meta-information acquisition unit
102 Setup information creation unit
103 Screen creation unit
20 Storage unit
200-1 to 200-n Template screen
201 Setup item
202 Setup condition
30 Input instrument
40 Output instrument
2 Data source
3 Facility table
SYS Screen creation system

1. A screen creation system, comprising:
a setup information creation unit configured to create, based on a setup item and a setup condition that are predefined for a selected template screen in entirety, or each of constituent elements of the template screen, setup information, with respect to each setup item defined for the template screen in entirety, or the constituent elements of the template screen; and
a screen creation unit configured to create a screen, based on the template screen, and on the setup information created by the setup information creation unit.

2. The screen creation system according to claim 1, further comprising a meta-information acquisition unit configured to acquire meta-information on data,
wherein the setup information creation unit sets, as the setup information, the meta-information acquired by the meta-information acquisition unit.

3. The screen creation system according to claim 2,
wherein the meta-information acquisition unit also acquires meta-information on a facility, as the meta-information on the data, and
the setup information creation unit sets, as the setup information, the meta-information on the facility acquired by the meta-information acquisition unit.

4. A screen creation method, comprising:
a selection step of selecting a template screen;
a setup information creation step of creating, based on a setup item and a setup condition that are predefined for the template screen selected in entirety, or each of constituent elements of the template screen, setup information, with respect to each setup item defined for the template screen in entirety, or the constituent elements of the template screen; and
a screen creation step of creating a screen, based on the template screen, and on the setup information created.

5. The screen creation method according to claim 4, further comprising a meta-information acquisition step of acquiring meta-information on data,
wherein the setup information creation step sets the meta-information acquired, as the setup information.

6. The screen creation method according to claim 5,
wherein the meta-information acquisition step also acquires meta-information on a facility, as the meta-information on the data, and
the setup information creation step sets the meta-information on the facility acquired, as the setup information.
